(19) United States
(12) Patent Application Publication
(10) Pub. No.: US 2014/0246006 A1
(43) Pub. Date: Sep. 4, 2014

(54) GEMSTONE PROCESSING

(71) Applicant: SAHAJANAND TECHNOLOGIES PRIVATE LIMITED SAHAJANAND HOUSE, Saiyedpura Surat (IN)

(72) Inventor: Rahul Mahendrakumar Gaywala, Nanavat Surat (IN)

(21) Appl. No.: 14/352,639

(22) PCT Filed: Oct. 17, 2012
(86) PCT No.: PCT/IN2012/000687

§ 371 Date: Apr. 17, 2014

(30) Foreign Application Priority Data
Oct. 17, 2011 (IN) 2904/MUM/2011

(51) Int. Cl. B28D 5/00; B23Q 16/02

(52) U.S. Cl. CPC B28D 5/0082; B23Q 16/02
USPC 125/30.01; 269/63

(57) ABSTRACT

An indexing unit of a gemstone processing machine and a method for processing gemstones is described herein. In an embodiment, the indexing unit of the gemstone processing machine includes a base plate having a plurality of axially extending holes. The base plate is mounted on a mounting shaft, and the mounting shaft is coupled to an indexing mechanism for actuating the base plate. Further, the indexing unit includes a plurality of holders. A holder is disposed in each of the plurality of axially extending holes of the base plate, and each holder is configured to hold a gemstone for processing on the gemstone processing machine.

### TECHNICAL FIELD

The subject matter described herein, in general, relates to gemstone processing, and particularly but not exclusively, relates to an indexing unit of a gemstone processing machine.

### BACKGROUND

Typically, a raw gemstone, i.e., a gemstone as found in its natural state has a highly irregular geometry and includes many contaminations. A series of steps are involved in processing the raw gemstone to obtain a finished gemstone. Major steps involved in the processing can include planning, cleaving or sawing, bruting, polishing, and final inspection.

Usually, during the planning process, which is carried out before the actual processing of the gemstone is carried out, one or more three-dimensional profiles of the raw gemstone are obtained. Further,, from among the various profiles, one shape for the finished gemstone to be cut from the raw gemstone is selected, for example, based on a customer preference. Once the shape of the gemstone is finalized, the gemstone is further put through the above mentioned operations.

In the field of gemstone processing, precise processing of the gemstone according to the selected shape is important, particularly, in case of precious gemstones, such as diamonds, where the monetary value of the gemstone depends on its size and clarity. To achieve precise processing of a diamond, predetermined marking are formed on the surface of the diamond prior to the cutting operations, and the actual processing of the gemstone is performed in accordance with the markings.

With recent advancement in technology, various automated machines, such as computer numerical controlled (CNC) machines, are employed for processing and finishing raw gemstone. In such machines the three-dimensional profile of the gemstone can be either obtained in the form of a predetermined profile, or the automated machine can create the profile(s). Once the profile is obtained, the machine can select one of the shapes of the finished gemstone or allow the user to decide a final shape for the gemstone. Once the profile is selected, the machine performs the different operations on the gemstone. Such machines are usually configured to process one gemstone at a time. Once the processing of one gemstone is completed, the gemstone is dismounted and another gemstone is mounted on the machine for processing.

### SUMMARY

This summary is provided to introduce concepts related to an indexing unit of a gemstone processing machine and method for processing gemstones, and these concepts are further described below in the detailed description. This summary is not intended to identify essential features of the claimed subject matter nor is it intended for use in determining or limiting the scope of the claimed subject matter.

In an embodiment, the indexing unit of the gemstone processing machine includes a base plate having a plurality of axially extending holes. The base plate is mounted on a mounting shaft, and the mounting shaft is coupled to an indexing mechanism for actuating the base plate. Further, the indexing unit includes a plurality of holders. A holder is disposed in each of the plurality of axially extending holes of the base plate, and each holder is configured to hold a gemstone for processing on the gemstone processing machine.

### BRIEF DESCRIPTION OF THE DRAWINGS

The detailed description is described with reference to the accompanying figures. The same numbers are used throughout the figures to reference like features and components. Some embodiments of the method(s) in accordance with the present subject matter are described, by way of example only, and with reference to the accompanying figures, in which:

FIG. 1 illustrates a perspective view of an indexing unit for a gemstone processing machine, in accordance with an embodiment of the present subject matter.

FIG. 2 illustrates a cross-sectional schematic representation of the indexing unit, in accordance with an embodiment of the present subject matter.

FIG. 3 illustrates a top view of the indexing unit, in accordance with an embodiment of the present subject matter.

### DETAILED DESCRIPTION

Conventionally, processing of gemstones is achieved on automated machines on which various steps are performed as part of gemstone processing. The steps can include, for example, sawing, bruting, and polishing. Such conventional machines are usually configured to process one gemstone at a time. Once the processing of one gemstone is completed, the gemstone is dismounted and another gemstone is mounted on the machine for processing. However, with such machines, the process of gemstone processing becomes time consuming and may delay the processing of the other gemstones in the pipeline, thereby leading to increase in the down time and decrease in the productivity. In case the productivity of processing gemstones is to be increased, a number of gemstone processing machines have to be installed, which can include various marking, sawing or bruting machines. However, in such a case, there can be a substantial increase in infrastructural and operational costs of processing gemstones, and can be uneconomical and unaffordable, particularly for small and medium scale enterprises.

The present subject matter describes an indexing unit for a gemstone processing machine, and a method for processing of gemstones. The indexing unit according to the present subject matter facilitates the mounting of a plurality of gemstones for processing on the gemstone processing machine. Accordingly, as soon as one gemstone is processed, another gemstone which is already mounted on the indexing unit is subsequently positioned for processing, while the gemstone already processed is moved away from the processing system and dismounted.

According to an embodiment of the present subject matter, the indexing unit of the gemstone processing machine includes a base plate mounted and fixed on a mounting shaft. In one implementation, the base plate can be formed as a single integrated piece, whereas in another implementation, the base plate can be formed of a plurality of plates stacked together.

In the latter implementation, the various plates can be formed of different materials for cost effectiveness. For example, the plates at the extreme ends of the base plate can be formed of a strong and well machined material, while the plates stacked between these two plates can be formed of an inferior material. As a result, the cost of the gemstone processing machine is substantially reduced.

According to said embodiment, the base plate can be provided with a plurality of axially extending holes formed on an axial face of the base plate, such that the axially extending holes are substantially parallel to a central longitudinal axis of the base plate. Further, in each of the axially extending holes, a holder for holding a gemstone during gemstone processing can be disposed. The holder can be formed as a longitudinal member, say a shaft, which can be inserted into the axially extending hole of the base plate with a clearance fit, such that the holder is capable of motion while disposed in the axially extending hole.

Further according to an aspect of the present subject matter, the mounting shaft, on which the base plate is mounted, can be coupled to an indexing mechanism for actuating the base plate. The actuation of the base plate can be achieved either in a rotational motion or a translational motion or a combination thereof The indexing mechanism can be configured to index the base plate to allow the already processed gemstone to move away from the processing unit, and the gemstone already mounted on a subsequent holder to be positioned for processing. In an example, the indexing mechanism can be one of a stepper motor, a direct current motor, and an alternating current motor.

In addition, the holders can be coupled to an actuating mechanism for providing actuation of the holders in the respective axially extending hole. The actuating mechanism can be configured to provide rotational or translational motion or a combination of the two motions, to the holders while disposed in the respective axially extending holes. In one implementation, all the holders disposed in the axially extending holes can be coupled to a single actuating mechanism, whereas in another implementation, each holder can be provided with a separate actuating mechanism for individually controlling the motion of the holder. In one example, the actuating mechanism is one of a stepper motor, a direct current motor, and an alternating current motor.

Further, according to an aspect of the present subject matter, the holders can be coupled to the actuating mechanism through an operating member. The operating member can serve to transmit motion from the actuating mechanism to the holder, as well as provide torque or speed multiplication during the motion of the holders, as the need may be. In an example, the operating member can include one of a gear box, a chain drive, a belt drive, and a pinch roller system. As will be understood, in the same manner as described above, the operating member can be individually provided for each holder in case a separate actuating mechanism is provided; otherwise, the indexing unit can include a single operating member.

According to an embodiment, a total of six axially extending holes are provided within the base plate to support six holders. Further, during operation of the gemstone processing machine, on each of the six holders, a different gemstone can be mounted for processing. After one gemstone is processed, the base plate can be rotated to index the other gemstones in the processing position. While the gemstone is being processed, the previously processed gemstone can be dismounted from the holder and substituted with another gemstone. Thus, the down time for processing of the multiple gemstones is substantially eliminated, thereby increasing the productivity of the gemstone processing machine.

In addition, for differently processing the gemstones, the same processing unit of the gemstone processing machine can be used, while differently marked gemstones can be actuated according to the required cutting and processing. As understood, the actuation can be performed by the actuation of the holder by the actuating mechanism, as well as by the actuation of the base plate by the indexing mechanism. Further, according to an aspect, the above described method for processing gemstones on a gemstone processing machine is also included herein as part of the present subject matter.

These and other advantages of the present subject matter would be described in a greater detail in conjunction with the following figures. It should be noted that the description and figures merely illustrate the principles of the present subject matter.

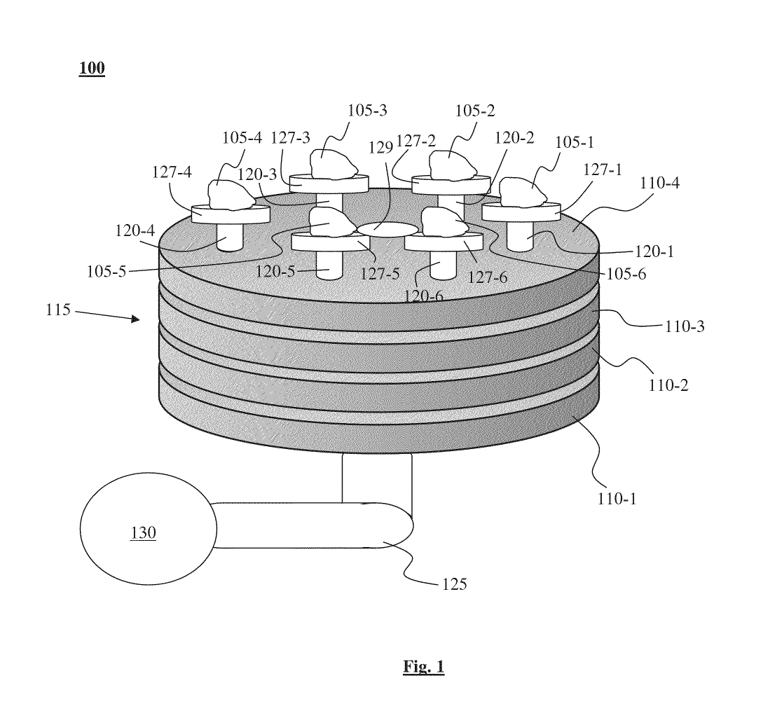

FIG. 1 illustrates a perspective view of an indexing unit 100 of a gemstone processing machine (not shown in FIG. 1). The indexing unit 100 according to the present subject matter facilitates the mounting of a plurality of gemstones 105-1, 105-2, 105-3, 105-4, 105-5, and 105-6, collectively referred to as gemstones 105 hereinafter, for processing on the gemstone processing machine. Accordingly, as soon as one gemstone 105 is processed, another gemstone 105 which is already mounted on the indexing unit is subsequently positioned for processing, while the gemstone 105 already processed is moved away from the processing system and dismounted. As a result, the employment of the indexing unit 100 in the gemstone processing machines reduces the down time required for mounting and demounting the gemstones 105 in the gemstone processing machine.

In an embodiment, the indexing unit 100 can serve acts as mechanism for mounting and rotating the plurality of gemstones 105 together in the gemstone processing machine. In one embodiment, the indexing unit 100 may be used, for example, in a laser planning machine, a laser sawing machine or a laser bruting machine for processing a plurality of gemstones.

As shown in FIG. 1, the indexing unit 100 includes a base plate 115. In an embodiment, the base plate 115 can be formed of a plurality of plates stacked together. In one example, a total of four circular plates 110-1, 110-2, 110-3, and 110-4 can be stacked together to form the base plate 115 of the indexing unit 100. For the purpose of this description, the plates 110-1, 110-2, 110-3, and 110-4 are collectively referred to as plates 110 hereinafter. According to an implementation, the various plates 110 can be formed of different materials for cost effectiveness. For example, the plates 110-1 and 110-4 at the extreme ends of the base plate 115 can be formed of a strong and well machined material, while the plates 110-2 and 110-3 stacked between these two plates 110-1 and 110-4 can be formed of an inferior material. As a result, the cost of the gemstone processing machine is substantially reduced. In another implementation, however, the base plate 115 can be formed as a single integrated piece formed of a single material.

Further, in an embodiment, the base plate 115 is provided with a plurality of axially extending holes (not shown in FIG. 1) on an axial face, for accommodating holders 120-1, 120-2, 120-3, 120-4, 120-5, and 120-6, collectively referred to as holders 120. However, it will be understood that based on the mounting and configuration of the base plate 115 on the gemstone processing machine, the configuration and location of the axially extending holes can also be accordingly changed. For example, in case the base plate 115 is mounted with the axis being substantially horizontal to the ground, and the gemstone processing machine is provided to process in a vertical direction with reference to the ground, then the holes can be provided on a radial face of the base plate 115.

In an implementation, each of the holders 120 can be formed of a longitudinal member, such as a shaft, and provided with a clamp for holding the gemstones 105. Accordingly, as can be seen from the figure, the holders 120 are provided with clamps 127-1, 127-2, 127-3, 127-4, 127-5, and 127-6 at their top end for holding the gemstones 105. However, in another case, the holders 120 can be provided with seats or other appropriate holding mechanism for holding the gemstone 105.

According to an embodiment, the base plate 115 is mounted on a mounting shaft 125 and is capable of motion while being mounted on the mounting shaft 125. For the purpose of allowing motion to the base plate 115, the base plate 115 can be fixedly mounted on the mounting shaft 125. In said implementation, the base plate 115 can be mounted on the mounting shaft 125 at a central hole 129, such that an interference or press fit is achieved between the base plate 115 and the mounting shaft 125. However, in another implementation, the base plate 115 can be mounted such that the connection between the base plate 115 and the mounting shaft 125 is formed as a clearance fit.

Further to provide motion to the base plate 115, the mounting shaft 125 can be coupled to an indexing mechanism 130. The mounting shaft 125 can be actuated by means of the indexing mechanism 130. The indexing mechanism 130 can, in turn, transfer the motion to the base plate 115. In an example, the indexing mechanism 130 of the present subject matter can be a stepper motor, an alternating current motor, or a direct current motor. The purpose of the indexing mechanism 130 is to index the gemstones 105 in the processing position for processing the gemstone 105. In another example, the indexing mechanism 130 can be provided with homing reference, say on the base plate 115, based on which the indexing mechanism 130 can achieve the indexing of the gemstones 105 in order to position the gemstones 105 for processing.

In an example, the base plate 115 can be configured to be capable of tilting, rotational motion about its axis, as well as translational motion. The base plate 115, with the help of the indexing mechanism 130, can provide for indexing the gemstones with reference to a processing unit of the processing machine, during operation of the processing machine for processing the gemstones. After one gemstone 105 is processed, the base plate 115 can be indexed and rotated so that the other gemstones 105 are in the processing position. While another gemstone 105 is being processed, the previously processed gemstone 105 can be dismounted from the holder 120 and substituted with another gemstone 105.

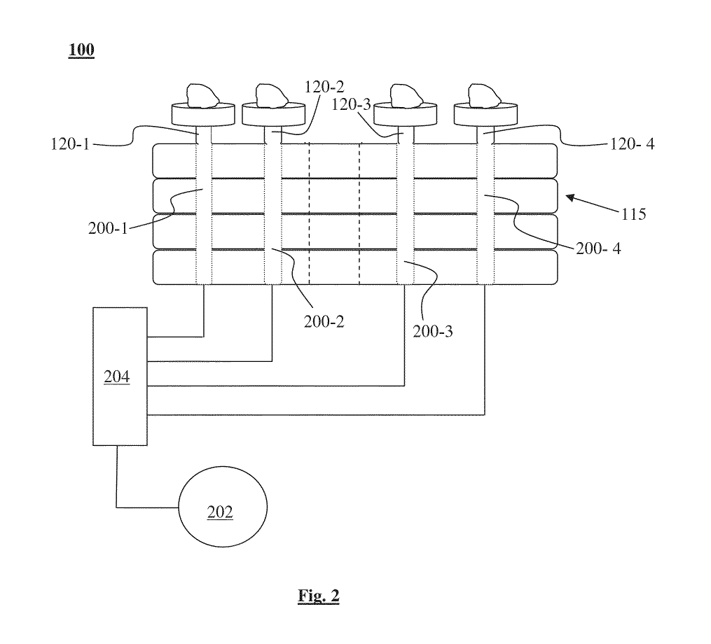

FIG. 2 illustrates a cross-sectional schematic representation of the indexing unit 100, in accordance with one embodiment of the present subject matter. As mentioned previously, the base plate 115 includes a plurality of axially extending holes 200-1, 200-2, 200-3, and 200-4, collectively referred to as the axially extending holes 200, for accommodating the holders 120. In an example, the axially extending holes 200 can be blind holes, whereas in another example, the axially extending holes 200 can be through-holes.

In one embodiment, the holders 120 are disposed in the axially extending holes 200 in such a way that the holders 120 are capable of rotational and translational motion inside the axially extending holes 200. In an example, to allow the motion of the holders 120 inside the axially extending holes 200, the holders 120 can be supported within the axially extending holes 200 with the help of bearings, say roller bearings (not shown in FIG. 2).

Further, according to an embodiment, the holders 120 can be coupled to an actuating mechanism 202. The actuating mechanism 202 can be configured to provide the rotational, translational, and combined motion to the holders 120. In one implementation, all the holders 120 disposed in the axially extending holes 200 can be coupled to a single actuating mechanism 202. In another implementation, each holder 120 can be provided with a separate actuating mechanism 202 for individually controlling the motion of the holder. In one example, the actuating mechanism 202 can be a stepper motor, a direct current motor, or an alternating current motor.

Further, according to said embodiment, the actuating mechanism 202 is coupled to the holders 120 through an operating member 204. The operating member 204 can serve to transmit motion from the actuating mechanism 202 to the holders 120, as well as provide torque or speed multiplication during the motion of the holders 120, as the need may be. In an example, the operating member 204 can include one of a gear box, a chain drive, a belt drive, and a pinch roller system. As will be understood, in the same manner as described above, the operating member 204 can be individually provided for each holder 120 in case a separate actuating mechanism 202 is provided. In another case, a single operating member 204 can be provided in the indexing unit 100.

The actuating mechanism 202 and the operating member 204 thus allow for the motion of the holders 120 during the operation of the gemstone processing machine for processing the gemstones. The holders 120 can be provided with various types of motion, say tilting, rotational, and translational motion, for cutting and processing the gemstone in the required shape.

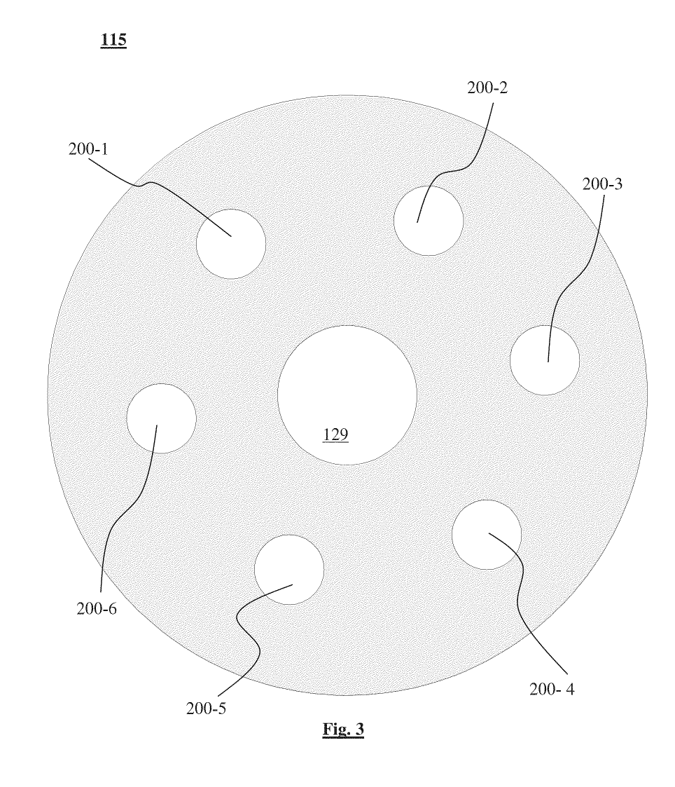

FIG. 3 illustrates a top view of the base plate 115 of the indexing unit 100, in accordance with one embodiment of the present subject matter. As shown herein, the base plate 115 of the present subject matter has the central hole 129 for mounting on the mounting shaft 125. Additionally, the axially extending holes 200 on the axial surface of the base plate 115 are also seen. In an example, the base plate 115 can include six axially extending holes 200 to accommodate six holders 120. As seen, in the present embodiment, the axially extending holes 200 are provided circumferentially equidistant from each other and also to be equidistant from the central longitudinal axis. However, in other embodiments, other configurations of the axially extending holes 200 can be achieved.

The indexing unit 100 of the present subject matter facilitates the processing, of various gemstones 105 with a reduction in the down time required for mounting and demounting the gemstones 105. Further, the employment of multiple holders 120 increases the productivity of the gemstone processing machine. In an example, the indexing unit 100 of the present subject matter can be employed in a computer assisted gemstone processing machines, such as a computer numeric controlled (CNC) machine. In such a case, each holder 120 can be identified by a packet number. The details concerning the packet numbers of various holders 120, for identifying the holder 120 and the associated processing of the gemstone mounted on that holder 120, can be introduced within a central server (not shown in the figure) in the form of barcodes. In an example, the central server can be coupled to the computer control module of the indexing unit 100 or the gemstone processing machine.

Further, according to an aspect of the present subject matter, a method for processing the gemstones 105 on the gemstone processing machine is described. According to the method, the gemstone 105 is mounted in one of the holders 120 disposed in the axially extending hole 200 in the base plate 115. For processing the gemstone 105, the base plate 115 is actuated by the indexing mechanism 130 and the holder 120 is actuated by the actuating mechanism 202. Further, the gemstone 105 mounted on the holder 120 is processed using the various processing steps, for example, sawing or cleaving, bruiting, polishing, and final inspection, by actuating the base plate 115 and the holder 120. However, it will also be understood that during processing one of the base plate 115 and the holder 120 can be kept stationary, while actuating the other.

According to an aspect, while one gemstone 105 is being processed another gemstone 105 is mounted in a subsequent holder 120. Once the processing of the first gemstone 105 is completed, the base plate 115 is indexed, with the help of the indexing mechanism 130, to position the other holder 120 for processing the subsequent gemstone 105. As will be understood, as the base plate 115 is indexed, the processed gemstone is positioned away from the processing unit of the gemstone processing machine, and can be dismounted. Subsequently, the other gemstones are processed on the gemstone processing machine in the same manner as described.

Although the subject matter has been described in considerable detail with reference to certain embodiments thereof, other embodiments are also possible. As such, the appended claims should not be limited to the description of the embodiment described herein.

I/we claim:

1. An indexing unit (100) of a gemstone processing machine, the indexing unit (100) comprising:
a base plate (115) having a plurality of axially extending holes (200), the base plate (115) being mounted on a mounting shaft (125);
an indexing mechanism (130) coupled to the mounting shaft (125) for actuating the base plate (115); and
a plurality of holders (120), wherein a holder (120) is disposed in each of the plurality of axially extending holes (200) of the base plate (115), each of the plurality of holders (120) being configured to hold a gemstone (105) for processing on the gemstone processing machine.

2. The indexing unit (100) as claimed in claim 1, wherein the plurality of holders (120) are coupled to an actuating mechanism (202) for providing actuation of each of the plurality of holders (120) in the respective axially extending hole (200).

3. The indexing unit (100) as claimed in claim 2, wherein the plurality of holders (120) are coupled to the actuating mechanism (202) through an operating member (204), the operating member (204) being one of a gear box, a chain drive, a belt drive, and a pinch roller system.

4. The indexing unit (100) as claimed in claim 2, wherein the actuating mechanism (202) is one of a stepper motor, a direct current motor, and an alternating current motor.

5. The indexing unit (100) as claimed in claim 2, wherein the actuating mechanism (202) is configured to provide at least one of a rotational and translational motion to the plurality of holders (120).

6. The indexing unit (100) as claimed in claim 1, wherein the base plate (115) is formed of a plurality of stacked plates (110-1, 110-2, 110-3, and 110-4).

7. The indexing unit (100) as claimed in claim 1, wherein the indexing mechanism (130) is one of a stepper motor, a direct current motor, and an alternating current motor.

8. A method for processing gemstones (105) on a gemstone processing machine, the method comprising:
mounting a gemstone (105) in one of a plurality of holders (120) disposed in a base plate (115), each of the plurality of holders (120) disposed in an axially extending hole (200) formed on a horizontal surface of the base plate (115), wherein the base plate (115) is coupled to an indexing mechanism (130) for actuation, and wherein the plurality of holders (120) are coupled to an actuating mechanism (202) for actuation;
processing the gemstone (105) mounted on the one of the plurality of holders (120), the processing being achieved by actuating at least one of the base plate (115) and the one of the plurality of holders (120), wherein another gemstone (105) is mounted in another holder (120) from among the plurality of holders (120) during the processing;
indexing the base plate (115) to position the other holder (120) for processing the other gemstone (105), wherein the processed gemstone (105) is dismounted from the holder (120) during the indexing; and
processing the other gemstone (105).

9. The method as claimed in claim 8, wherein the indexing comprises actuating the base plate (115) by the indexing mechanism (130).

10. The method as claimed in claim 8, wherein the processing comprises actuating the base plate (115) and the holder (120) in at least one of a directional motion and a translational motion.
